(19) United States
(12) Patent Application Publication
(10) Pub. No.: US 2026/0077656 A1
(43) Pub. Date: Mar. 19, 2026

(54) MODULAR POWER-AGNOSTIC WORK VEHICLE

(71) Applicant: Komatsu America Corp., Chicago, IL (US)

(72) Inventors: Brad Roper, Dunlap, IL (US); Dan Brown, Williamsfield, IL (US); Logan S. Watters, Harrogate, TN (US); Graham McNally, Morton, IL (US); Bill Walker, Dunlap, IL (US)

(21) Appl. No.: 19/331,770

(22) Filed: Sep. 17, 2025

Related U.S. Application Data
(60) Provisional application No. 63/696,336, filed on Sep. 18, 2024.

(51) Int. Cl. B60L 7/22; B60L 1/00; B60L 50/15; B60L 50/53; B62D 63/02

(52) U.S. Cl. CPC B60L 7/22; B60L 1/003; B60L 50/15; B60L 50/53; B62D 63/025; B60L 2200/36; B60L 2200/40

(57) ABSTRACT

Systems and methods for a modular power-agnostic work vehicle are provided. A work vehicle includes: a main frame, a traction motor: driven by a power source, and converting mechanical energy into electrical energy, a wheel on an axle connected to the main frame driven by the traction motor, a platform, a power interface, a control interface controlling: a primary H-bridge, a cooling system, and a motor inverter: providing power to the motor to rotate the axle, and receiving the electrical energy, a cooling blower inverter interface controlling: auxiliary inverters providing power to: the cooling system and blowers, and a secondary H-bridge controlling current flow, and retarding grid units, at least a first retarding grid unit supported directly on an upper surface of a second retarding grid unit, each retarding grid unit: converting the electrical energy received by the motor inverter from the traction motor into heat, and dissipating the heat.

### CROSS-REFERENCE TO RELATED APPLICATION(S)

This application claims the benefit of and priority to U.S. Provisional Ser. No. 63/696,336 , filed on Sep. 18, 2024, the entire disclosure of which is incorporated herein by reference for all purposes.

### TECHNICAL FIELD

Embodiments described herein relate to systems and methods for a modular power-agnostic work vehicle.

### SUMMARY

A work vehicle, e.g., a truck, is used in off-road applications, such as construction, mining and the like. Conventional work vehicles are manufactured with a single type of power source, such as a combustion engine, a diesel engine, a natural gas engine, a rechargeable energy storage unit, a battery, a trolley, a hydrogen fuel cell, and hybrids thereof.

When the vehicle travels downhill or on a flat surface or the vehicle is slowing, the vehicle's momentum provides the forward force for continuing travel, and there is no need to use the engine to generate motive power. However, the movement of the vehicle generates extra power, which is typically dissipated by passing electrical energy through a retarding grid to be converted to heat. The electrical energy is passed through resistors, which get hot. One or more blowers (or fans) in the retarding grid blow air across resistors to dissipate heat into the ambient atmosphere. Example embodiments may provide a unit for dissipating heat that is easily configurable for different power sources. In addition, example embodiments may increase power efficiency by reclaiming at least some electric power to be stored a power storage device, e.g., a battery.

Embodiments described herein provide systems and methods for reclaiming electric energy that would be otherwise converted to heat and storing that energy in a storage device, e.g., a battery, for use in powering the work vehicle. Example embodiments include various power sources, such as a combustion engine, a diesel engine, a natural gas engine, a rechargeable energy storage unit, a battery, a trolley, a hydrogen fuel cell, and hybrids thereof. Example embodiments have a modular design in which the power source can be changed at any time in the life cycle of the work vehicle. In example embodiments, the number and configuration of one or more modular retarding grids can be selected or changed, e.g., according to the heat dissipation needs of the selected power source.

In one independent aspect, a work vehicle includes: a main frame configured to selectively receive a power source including one of a first type of power source and a second type of power source, the first type of power source being different from the second type of power source, a traction motor connected to the main frame, the traction motor being configured to: be driven by the one of the first type of power source and the second type of power source, and convert excess mechanical energy into electrical energy, a wheel on an axle connected to the main frame, the wheel on the axle being configured to be driven by the traction motor, a platform connected to the main frame in a position higher than the wheel, a power interface disposed on the platform, the power interface being configured to manage power from the power source, a control interface disposed on the platform, the control interface being configured to control: a primary H-bridge configured to control current flow through the motor, a cooling system, and a motor inverter configured to: provide power to the motor to rotate the axle, and receive the converted electrical energy from the traction motor, a cooling blower inverter (CBI) interface disposed on the platform, the CBI interface being configured to control: a plurality of auxiliary inverters respectively configured to provide power to: the cooling system, and a plurality of blowers, and a secondary H-bridge configured to control current flow through the plurality of auxiliary inverters, and a plurality of retarding grid units disposed on the platform, at least a first of the plurality of retarding grid units being supported directly on an upper surface of a second of the retarding grid units, each of the plurality of retarding grid units being configured to: convert the electrical energy received by the motor inverter from the traction motor into heat, and dissipate the heat into an ambient area.

In some aspects, the power source includes a combustion engine, and a number of the plurality of retarding grid units is three.

In some aspects, the power source includes a rechargeable energy storage unit, a number of the plurality of retarding grid units is two, and the work vehicle further includes a power reclaiming unit configured to: receive electrical energy from the motor inverter, convert at least a portion of the electrical energy received from the motor inverter into a DC electrical energy, and store the DC electrical energy in the rechargeable energy storage unit.

In some aspects, when the electrical energy received from the motor inverter is greater than a storage capacity of the rechargeable energy storage unit, the plurality of retarding grid units is further configured to dissipate a portion of the received electrical energy corresponding to the electrical energy that is greater than a storage capacity of the rechargeable energy storage unit.

In some aspects, each of the plurality of retarding grid units includes: one or more resistor banks, each of the one or more resistor banks respectively including one or more resistors, each of the one or more resistors being configured to: receive electrical energy from the motor inverter, and convert the electrical energy into heat, a blower configured to pass air over the one or more resistor banks to dissipate the heat into the ambient area, and a housing configured to surround the one or more resistor banks and the blower, the housing including a frame, at least one end of the housing including a vent opening, the vent opening being configured to allow the dissipating heat to pass therethrough.

In some aspects, the power source is configured to be replaced with a replacement power source having a different type of power source from the power source, and when the power source is replaced with a replacement power source, when the power source is a combustion engine, and when the replacement power source is a rechargeable energy storage unit, the work vehicle is configured such that at least one of the plurality of retarding grid units is replaced with a power reclaiming unit configured to: receive the electrical energy from the motor inverter, convert at least a portion of the electrical energy received from the motor inverter into a DC electrical energy, and store the DC electrical energy in the rechargeable energy storage unit.

In some aspects, the power source is configured to be replaced with a replacement power source having a different type of power source from the power source, and when the power source is replaced with a replacement power source, when the power source is a rechargeable energy storage unit, and when the replacement power source is a combustion engine, the work vehicle is configured such that a power reclaiming unit configured to convert at least a portion of the electrical energy received from the motor inverter into a DC electrical energy is replaced with at least one more of the plurality of retarding grid units.

Some aspects further include a trolley box disposed on the platform, the trolley box being configured to receive external electrical energy as the power source.

In some aspects, the cooling system includes a liquid cooling system.

In another independent aspect, a method for operating a work vehicle includes: selectively receiving, at a main frame, a power source including one of a first type of power source and a second type of power source, the first type of power source being different from the second type of power source, driving a traction motor, connected to the main frame, by the one of the first type of power source and the second type of power source, and converting, by the traction motor, excess mechanical energy into electrical energy, driving, by the traction motor, a wheel on an axle connected to the main frame, managing power from the power source by a power interface disposed on a platform connected to the main frame in a position higher than the wheel, controlling, by a control interface disposed on the platform: a primary H-bridge controlling current flow through the motor, a cooling system, and a motor inverter: providing power to the motor to rotate the axle, and receiving the converted electrical energy from the traction motor, controlling, by a cooling blower inverter (CBI) interface disposed on the platform: a plurality of auxiliary inverters respectively providing power to: the cooling system, and a plurality of blowers, and a secondary H-bridge controlling current flow through the plurality of auxiliary inverters, and converting the electrical energy received by the motor inverter from the traction motor into heat by a plurality of retarding grid units disposed on the platform, at least a first of the plurality of retarding grid units being supported directly on an upper surface of a second of the retarding grid units, and dissipating the heat, by each of the plurality of retarding grid units, into an ambient area.

In some aspects, the power source includes a combustion engine, and a number of the plurality of retarding grid units is three.

In some aspects, the power source includes a rechargeable energy storage unit, a number of the plurality of retarding grid units is two, and the method further includes: receiving electrical energy, by a power reclaiming unit of the work vehicle, from the motor inverter, converting, by the power reclaiming unit, at least a portion of the electrical energy received from the motor inverter into a DC electrical energy, and storing, by the power reclaiming unit, the DC electrical energy in the rechargeable energy storage unit.

Some aspects further include, when the electrical energy received from the motor inverter is greater than a storage capacity of the rechargeable energy storage unit, the plurality of retarding grid units dissipating a portion of the received electrical energy corresponding to the electrical energy that is greater than a storage capacity of the rechargeable energy storage unit.

In some aspects, each of the plurality of retarding grid units includes: one or more resistor banks, each of the one or more resistor banks respectively including one or more resistors, each of the one or more resistors: receiving electrical energy from the motor inverter, and converting the received electrical energy into heat, a blower passing air over the one or more resistor banks to dissipate the heat into the ambient area, and a housing surrounding the one or more resistor banks and the blower, the housing including a frame, at least one end of the housing including a vent opening, the vent opening allowing the dissipating heat to pass therethrough.

Some aspects further include replacing the power source with a replacement power source having a different type of power source from the power source, and when the power source is replaced with a replacement power source, when the power source is a combustion engine, and when the replacement power source is a rechargeable energy storage unit, replacing at least one of the plurality of retarding grid units with a power reclaiming unit that: receives the electrical energy from the motor inverter, converts at least a portion of the electrical energy received from the motor inverter into a DC electrical energy, and stores the DC electrical energy in the rechargeable energy storage unit.

Some aspects further include replacing the power source with a replacement power source having a different type of power source from the power source, and when the power source is replaced with a replacement power source, when the power source is a rechargeable energy storage unit, and when the replacement power source is a combustion engine, the work vehicle is configured such that a power reclaiming unit configured to convert at least a portion of the electrical energy received from the motor inverter into a DC electrical energy is replaced with at least one more of the plurality of retarding grid units.

Some aspects further include receiving external electrical energy as the power source via a trolley box disposed on the platform.

In some aspects, the cooling system includes a liquid cooling system.

Other aspects of the embodiments will become apparent by consideration of the detailed description and accompanying drawings.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 is a perspective view of a work vehicle in accordance with an example embodiment of the present disclosure.

FIG. 2 is a perspective view of the work vehicle of FIG. 1.

FIG. 3 is a perspective view of equipment on a platform of a work vehicle in accordance with an example embodiment of the present disclosure.

FIG. 4 is a schematic view of the equipment shown in FIG. 3.

FIG. 5 is a perspective view of equipment on a platform of a work vehicle in accordance with an example embodiment of the present disclosure.

FIG. 6 is a schematic view of the equipment shown in FIG. 5.

FIG. 7 is a schematic view of a platform layout for a work vehicle in accordance with an example embodiment of the present disclosure.

FIG. 8 is a perspective view of retarding grid boxes in accordance with an example embodiment of the present disclosure.

FIG. 9 is a perspective view of a trolley box in accordance with an example embodiment of the present disclosure.

FIG. 10 is a perspective view of a trolley contacting box in accordance with an example embodiment of the present disclosure.

FIG. 11 is a schematic view of a platform layout for a work vehicle in accordance with an example embodiment of the present disclosure.

FIG. 12 is a perspective view of retarding grid boxes in accordance with an example embodiment of the present disclosure.

FIG. 13 is a perspective view of a battery transformer package in accordance with an example embodiment of the present disclosure.

FIG. 14 is a perspective view of an auxiliary power box in accordance with an example embodiment of the present disclosure.

FIG. 15 is a flowchart of a method in accordance with an example embodiment of the present disclosure.

FIG. 16 illustrates certain components that may be included within a computer system according to an example embodiment of the present disclosure.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

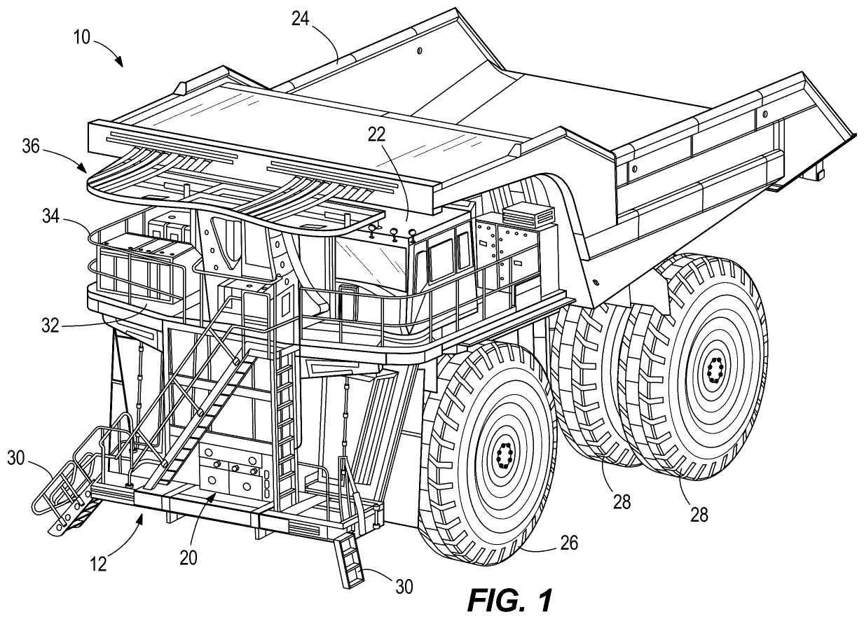

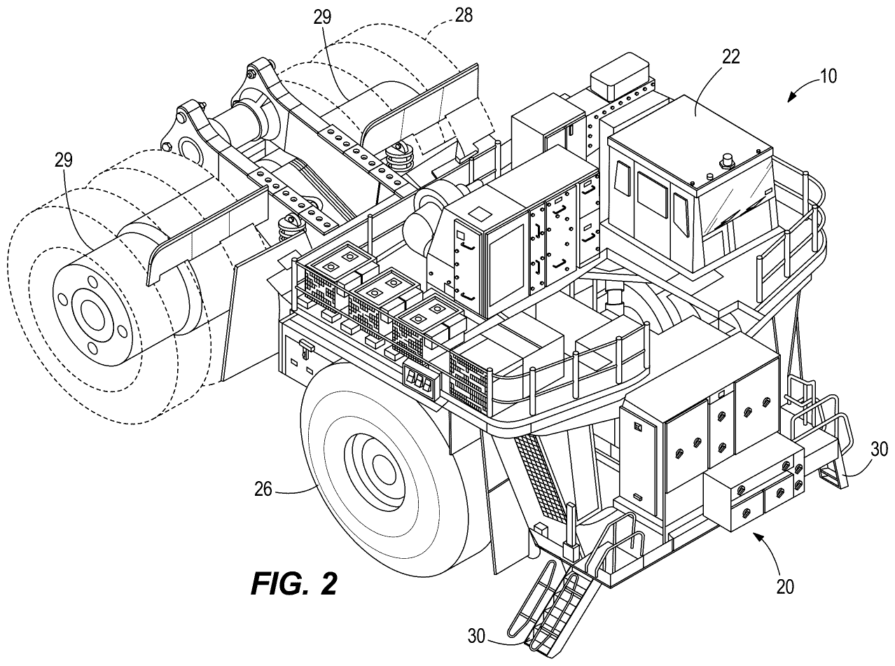

FIG. 1 is a perspective view of a work vehicle in accordance with an example embodiment of the present disclosure. FIG. 2 is a perspective view of the work vehicle of FIG. 1.

With reference to FIGS. 1-2, a work vehicle 10 may include a main frame 12 configured to selectively receive a power source of one of a first type of power source and a second type of power source. The first type of power source is different from the second type of power source. For example, the first and second types of power sources may be any of: a combustion engine, a diesel engine, a natural gas engine, a rechargeable energy storage unit, a battery, a trolley, a hydrogen fuel cell, or any hybrid thereof. Each of the first type of power source and the second type of power source may be respectively mounted on a first sub-frame or a second sub-frame. In the example shown in FIG. 1, a rechargeable energy storage unit, e.g., a battery 20, is shown as the power source, which may be selectively mounted to the main frame 12 of the work vehicle 10. The location of the power source, e.g., the battery 20, is not limited to the particular location shown in FIG. 1. The battery 20 can be either the first type of power source or the second type of power source, in other words, the vehicle may be initially configured with a battery or a battery may be installed at a later time by switching from another type of power source. Although the work vehicle 10 is illustrated in the FIG. 1 example as being a mining truck, the work vehicle 10 can be any vehicle capable of being run from different types of power sources.

The work vehicle 10 may include a cab 22 from which a driver may operate the work vehicle 10, as shown in FIG. 1. The cab 22 may be installed at an upper left, front part of the main frame 12, although embodiments are not limited to that position. The example work vehicle 10 illustrated in FIG. 1 is a dump truck, and so an example embodiment may include a dump body 24 that carries loads, such as mined rocks and stones, earth and sand, that may be movably connected to an upper rear part of the main frame 12. The dump body 24 may be moved by extensions and contractions of a cylinder (not shown).

A plurality of wheels 26 and 28 may be rotatably connected to the main frame 12, as shown in FIG. 1. A front wheel 26 may be disposed on each of the front-right and front-left sides of the work vehicle 10. A pair of rear wheels 28 may be disposed on each of the rear-right and rear-left sides of the work vehicle 10. It should be appreciated that embodiment are not limited to the illustrated example numbers of wheels or wheel positions. A traction motor 29 may be connected to the main frame 12, as shown in FIG. 2, and may be configured to be driven by the power source, e.g., the battery 20. At least the rear wheels 28 may be driven by a driving force supplied from the traction motor 29. The front wheels may be driven, for example, by the same traction motor 29 or by a separate traction motor. The plurality of wheels 26 and 28 may be rotatably connected to the main frame.

A plurality of ladders 30 may be provided on the front-right and the front-left sides of the main frame 12 to provide access to areas of the work vehicle 10, such as the cab 22, as shown in FIG. 1. A platform 32 may surround the cab 22, and may provide access to equipment disposed thereon. The platform 32 may be connected to the main frame 12 in a position higher than the wheels 26, 28. A handrail 34 may be provided to an outer perimeter of the platform 32.

The work vehicle 10 can be optionally equipped with a trolley line accessing system 36 configured to operate the work vehicle 10 via electrical power from an overhead trolley line when available. The work vehicle 10 can transition between an on-trolley mode in which power is received from an overhead trolley line and an off-trolley mode in which power is received from the work vehicle power source, e.g., the battery 20. The trolley line accessing system 36 may be movable between a collapsed position, as shown in FIG. 1, when an overhead trolly line is not available and an extended position (not shown) in which the trolley line accessing system 36 is raised to contact an overhead trolley line.

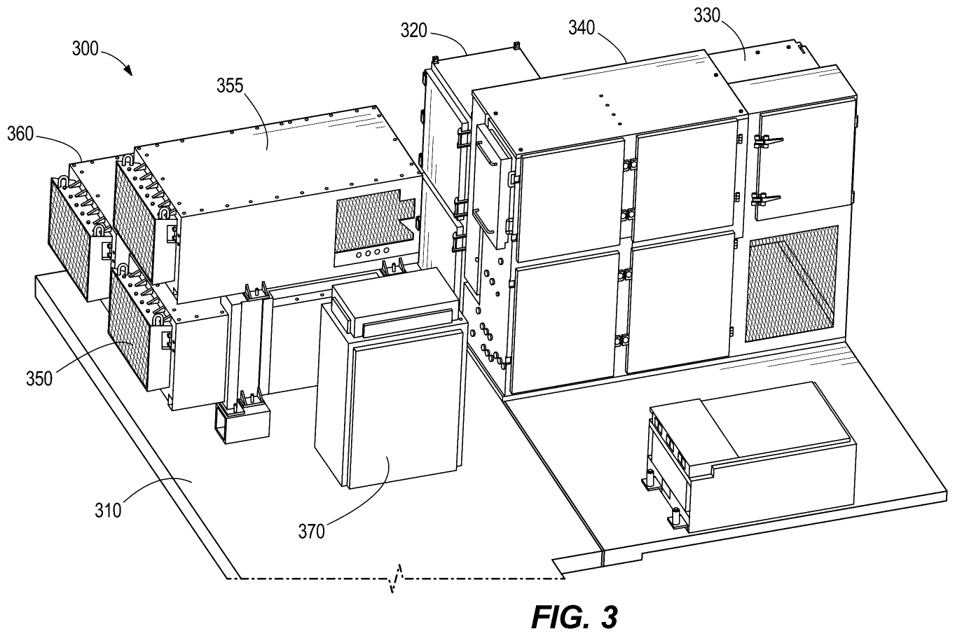

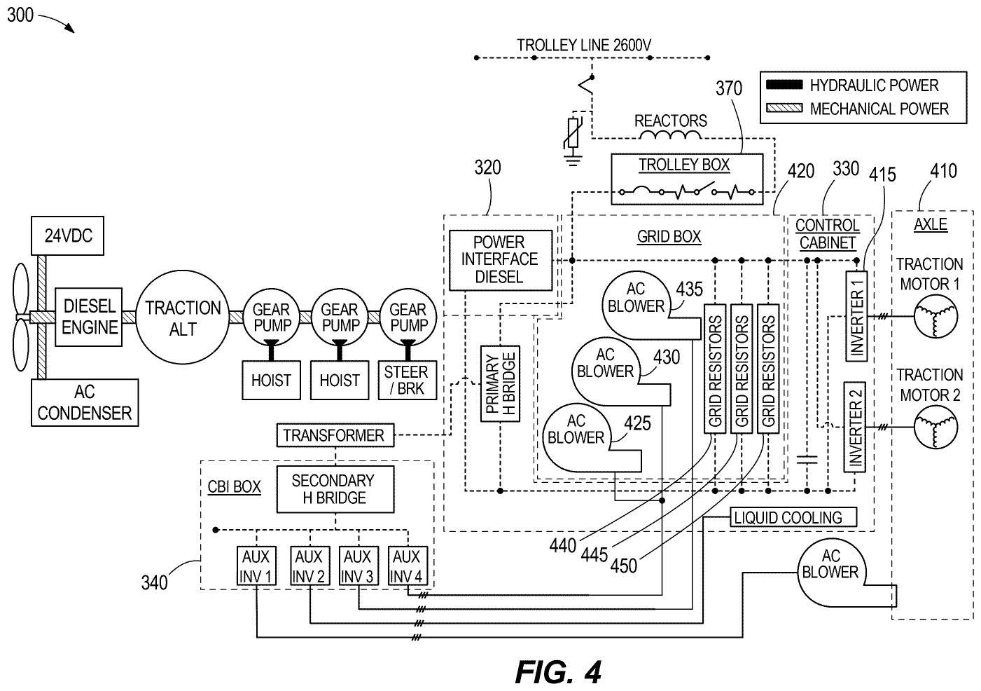

FIG. 3 is a perspective view of equipment on a platform of a work vehicle in accordance with an example embodiment of the present disclosure. FIG. 4 is a schematic view of the equipment shown in FIG. 3.

Various operational equipment may be provided on a platform 310, e.g., the platform 32 of FIG. 1, for operating a work vehicle 300. With reference to FIGS. 3 and 4, in an example in which the power source is a diesel engine, a power interface 320 for managing power from the power source, e.g., a diesel power interface, may receive power from the power source, e.g., the diesel engine, for example, 2600V, to operate the work vehicle 300. A control interface, e.g., a control cabinet 330, may control a primary H-bridge to control current flow through one or more motors, e.g., the traction motor 29 of FIG. 1, a cooling system, e.g., a liquid cooling system, and respective inverters for the axles 410 of the work vehicle for controlling one or more traction motors, e.g., the traction motor 29 of FIG. 1. A cooling blower inverter (CBI) interface, e.g., a CBI Box 340 may control auxiliary inverters for providing power to the cooling system and blowers or fans in other equipment, and a secondary H-bridge for controlling current flow through the inverters. Excess mechanical energy generated by the traction motor(s), for example, from mechanical power generated during braking, coasting, or downhill motion, may be tremendous, and may impede operation of the work vehicle if it is not dissipated safely. The traction motor(s) may convert excess mechanical energy into electrical energy, which may be received by respective inverters of the control cabinet 330, e.g., a motor inverter 415, into electrical energy, and then may be passed by the control cabinet 330 into grid resistors 440, 445, 450 of respective retarding grid units, e.g., retarding grid boxes 350, 355, 360. The overall amount of energy determined to be excess energy may be based on heat dissipation needs of the work vehicle, e.g., to avoid overheating.

In the example shown in FIG. 3, three retarding grid boxes, e.g., first, second, and third retarding grid boxes 350, 355, 360, are shown. The number of retarding grid boxes may be determined by space constraints on the platform 310. In addition, the second retarding grid box 355 is stacked on (e.g., supported directly on an upper surface of) the first retarding grid box 350. This configuration saves space on the platform 310 because the footprint of stacked retarding grid boxes is less than the footprint of the three retarding grid boxes 350, 355, 360 if they were all placed directly on the platform 310. Such a configuration may provide additional serviceability by providing for walkway access, e.g., service access, on the platform 310 to all cabinets, e.g., the power interface 320, the control cabinet 330, and the CBI Box 340.

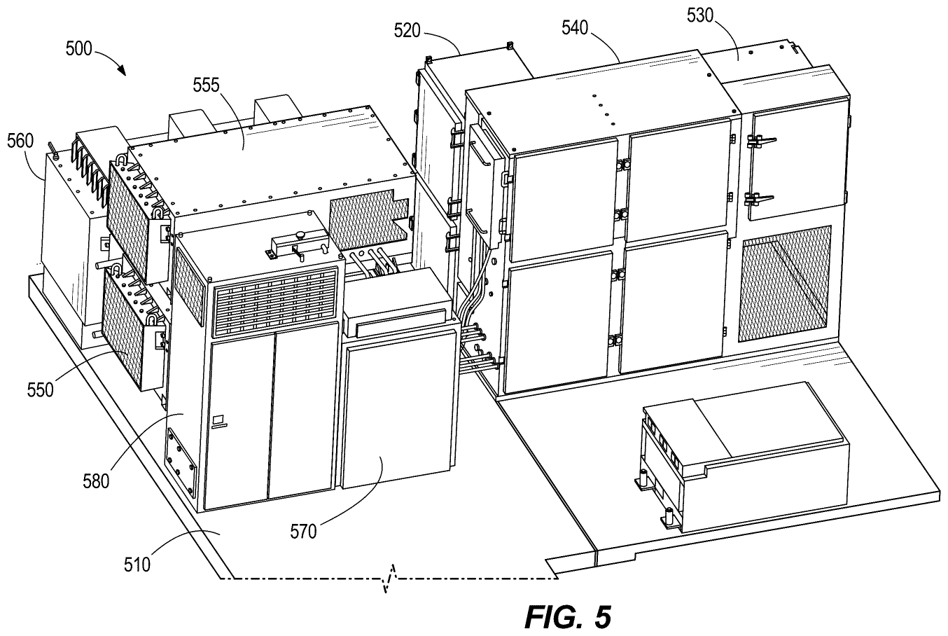

With reference to FIG. 4, a grid box control system 420 may control respective blowers 425, 430, 435 to blow on respective grid resistors 440, 445, 450 for each of the retarding grid boxes 350, 355, 360 of FIG. 5. The term “blower” is used herein broadly, and may refer to a blower, fan, or any device that provides forced air. In a configuration of the work vehicle 300 that includes a trolley system, e.g., the optional trolley line accessing system 36 of FIG. 1, a trolley control box 370 may be provided to control the trolley system.

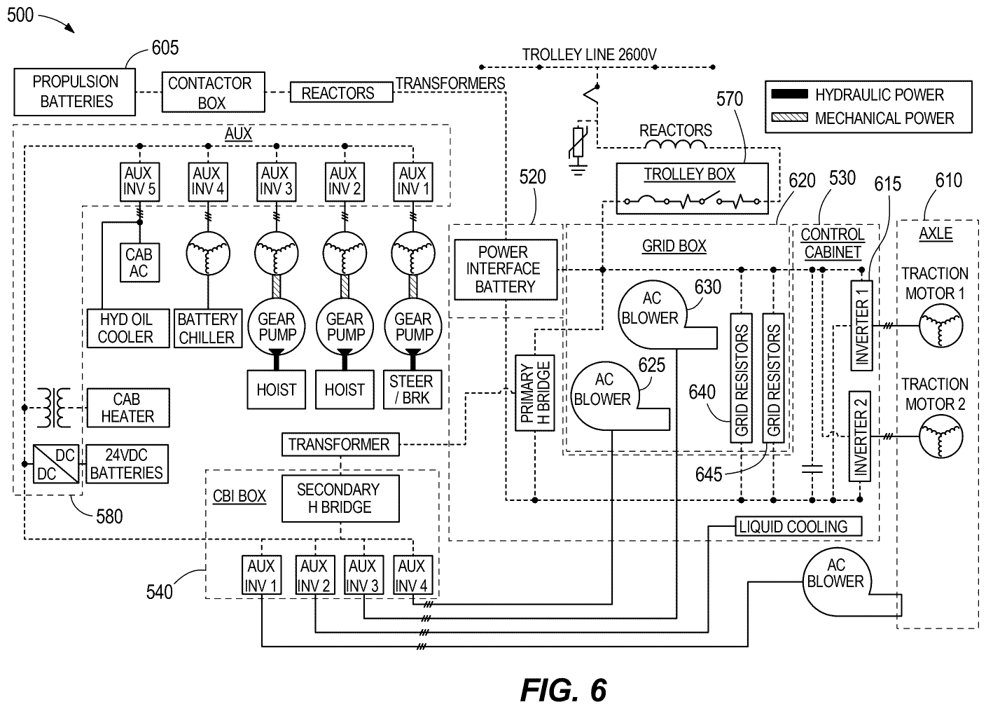

FIG. 5 is a perspective view of equipment on a platform of a work vehicle in accordance with an example embodiment of the present disclosure. FIG. 6 is a schematic view of the equipment shown in FIG. 5.

Various operational equipment may be provided on a platform 510, e.g., the platform 32 of FIG. 1, for operating a work vehicle 500. In the examples illustrated in FIGS. 5 and 6, the power source is a battery, for example, the battery 20 of FIG. 1, which may include one or more propulsion batteries 605 (FIG. 6). A power interface 520 for managing power from the power source, e.g., a battery power interface, may receive power from the power source, e.g., the battery, which may be converted, e.g., by transformers, to an operational voltage, for example, 2600V, to operate the work vehicle 500. A control interface, e.g., a control cabinet 530 may control a primary H-bridge to control current flow through one or more motors, e.g., the traction motor 29 of FIG. 1, a cooling system, e.g., a liquid cooling system, and respective inverters for the axles 610 of the work vehicle for controlling one or more traction motors, e.g., the traction motor 29 of FIG. 1. A cooling blower inverter (CBI) interface, e.g., a CBI Box 540 may control auxiliary inverters for providing power to the cooling system and blowers or fans in other equipment, and a secondary H-bridge for controlling current flow through the inverters. Other power for controlling the work vehicle 500 may be provided by the auxiliary power unit 580, which may receive power from the CBI Box 540. Excess mechanical energy generated by the traction motor(s), for example, from mechanical power generated during braking, coasting, or downhill motion, may be tremendous, and may impede operation of the work vehicle if it is not dissipated safely. The traction motor(s) may convert excess mechanical energy into electrical energy, which may be received by respective inverters of the control cabinet 530, e.g., motor inverter 615, into electrical energy, and then may be passed by the control cabinet 530 into grid resistors 640, 645 of respective retarding grid units, e.g., retarding grid boxes 550, 555.

In the example shown in FIG. 5, two retarding grid boxes, e.g., first and second retarding grid boxes 550, 555, are shown, with the second retarding grid box 555 stacked on (e.g., supported directly on an upper surface of) the first retarding grid box 550. This configuration saves space on the platform 510 because the footprint of stacked retarding grid boxes is smaller than the footprint of the two retarding grid boxes 550, 555 if they were both placed directly on the platform 510. Such a configuration may provide additional serviceability by providing for walkway access, e.g., service access, on the platform 310 to all cabinets, e.g., the power interface 320, the control cabinet 330, and the CBI Box 340.

With reference to FIG. 6, a grid box control system 620 may control respective blowers 625, 630 to blow on respective grid resistors 640, 645 for each of the retarding grid boxes 550, 555 of FIG. 5. In a configuration of the work vehicle 500 that includes a trolley system, e.g., the optional trolley line accessing system 36 of FIG. 1, a trolley control box 570 may be provided to control the trolley system.

In contrast with the example of FIG. 3 in which three retarding grid boxes 350, 355, 360 were provided, in the example of FIG. 5 two retarding grid boxes 550, 555 are illustrated. The number of retarding grid boxes may be based on constraints (e.g., the size of the platform 510). In the illustrated example of FIG. 5, in the space in which a third retarding grid box 360 was provided in FIG. 3, a power reclaiming unit 560 may be provided. The power reclaiming unit 560 may include, for example, a battery transformer. The power reclaiming unit 560 may receive the excess power, e.g., in the form of electrical energy transformed from mechanical energy by the motor e.g., the traction motor 29 of FIG. 1, and received via the motor inverter, e.g., motor inverter 615, for example, when the work vehicle 500 is braking, coasting on a flat surface, or moving downhill. The power reclaiming unit 560 may convert the electrical energy received from the inverters into a form of electrical energy that can be stored in an energy storage device, for example, a rechargeable energy storage unit, e.g., the battery 20 of FIG. 1. For example, the power reclaiming unit 560 may include a DC-to-DC (direct current-to-direct current) power converter that converts the electrical energy from the motor inverter to a voltage that can be handled by the rechargeable energy storage unit. In some examples, the rechargeable energy storage unit that stores the excess electrical energy may be the same as the rechargeable energy storage unit that provides motive power to the work vehicle, e.g., a “main battery” or a “propulsion battery.” In some example embodiments, the rechargeable energy storage unit that stores the excess electrical energy may be a separate unit that may recharge the energy storage unit that provides motive power to the work vehicle and/or may provide power to other systems on the work vehicle, e.g., climate control, HVAC, cameras, cooling systems, operative loads, a dump body, etc. Additional excess energy from the motor(s) that exceeds the capacity of the energy storage device may be converted to heat and dissipated by the retarding grid boxes, e.g., the retarding grid boxes 550, 555 in FIG. 5. The overall amount of energy determined to be excess energy may be based on energy storage capacity and heat dissipation needs of the work vehicle, e.g., to avoid overheating. For example, when the electrical energy received from the power converter or motor inverter is greater than a storage capacity of the rechargeable energy storage device or unit, the retarding grid boxes 550, 555 may dissipate a portion of the received electrical energy corresponding to the electrical energy that is greater than a storage capacity of the rechargeable energy storage device or unit.

When the vehicle travels downhill, on a flat surface, or slows down, its momentum provides the necessary forward force, eliminating the need for the engine to generate motive power. However, this movement generates excess power, which may be dissipated by converting electrical energy into heat through a retarding grid. This electrical energy passes through one or more resistor banks, e.g., resistors, causing them to heat up. Blowers or fans in the retarding grid then blow air across the resistors to dissipate the heat into the ambient atmosphere. Embodiments of the present disclosure can dissipate heat and be easily configurable for different power sources. Additionally, in example embodiments, power efficiency may be increased by reclaiming some of the electric power to store in a power storage device, such as a battery.

Example embodiments may reclaim and store electric energy that would otherwise be converted to heat, and then use that reclaimed energy to power the work vehicle, resulting in less overall energy consumption. Example embodiments may use various power sources, including a combustion engine, a diesel engine, a natural gas engine, a rechargeable energy storage unit, a battery, a trolley, a hydrogen fuel cell, and/or hybrids and/or multiples of these. Moreover, example embodiments may feature a modular design, allowing the power source to be changed (or replaced), e.g., with a replacement power source, at any point during the work vehicle's life cycle. The replacement power source may be the same type as or a different type from the original power source. Additionally, the number and configuration of the retarding grid boxes can be selected or adjusted based on the heat dissipation needs of the chosen power source and the available space on the platform of the work vehicle. When a trolley system is used, the trolley system may provide the motive power for the traction motors, and a separate rechargeable energy storage unit may be provided to store reclaimed power from the traction motors for use by various systems of the work vehicle. Even with the use of a combustion engine, a separate rechargeable energy storage unit may be provided to store reclaimed power from the traction motors for use by various systems of the work vehicle.

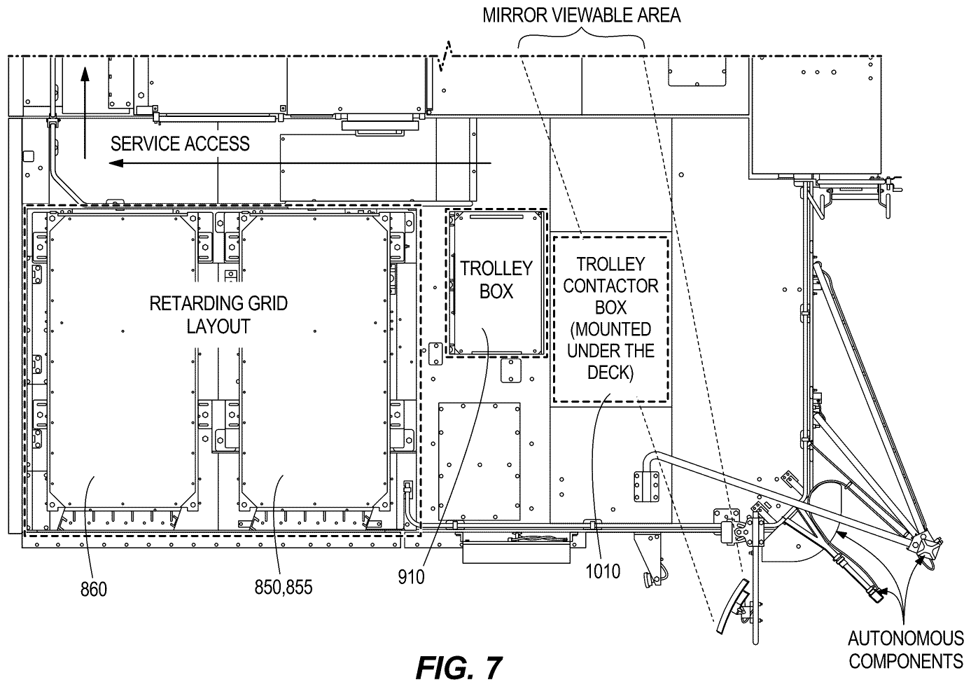

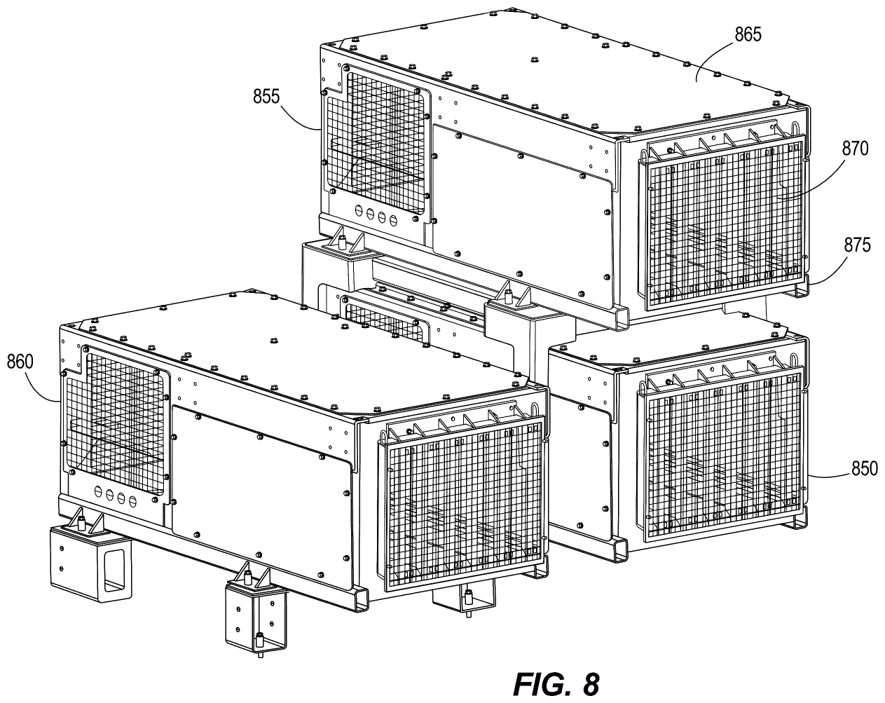

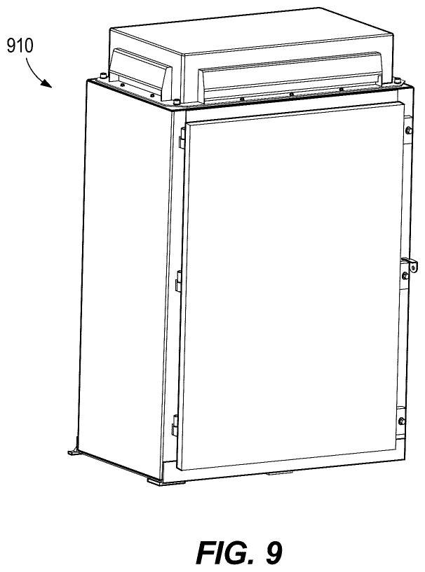

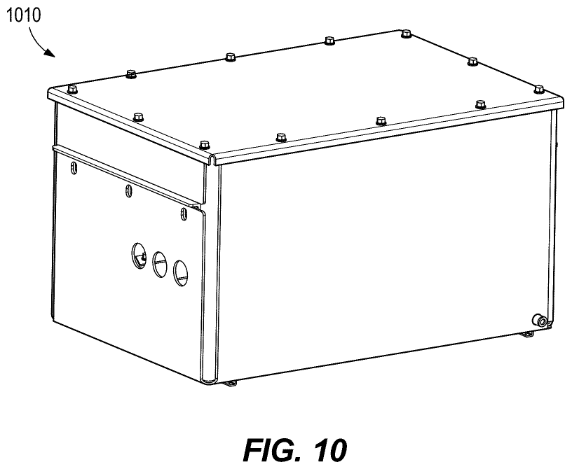

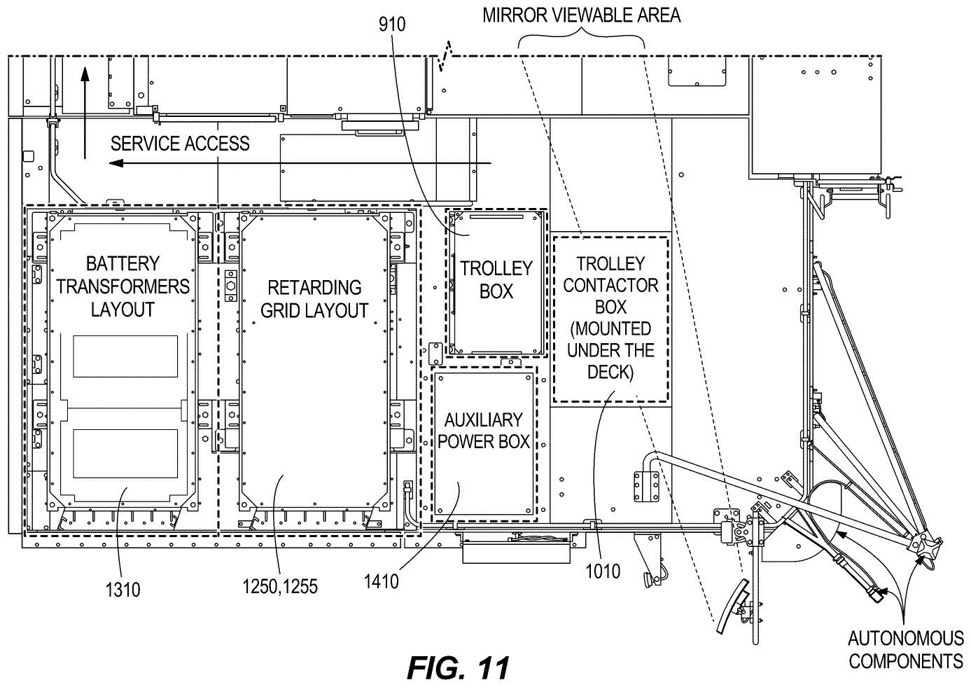

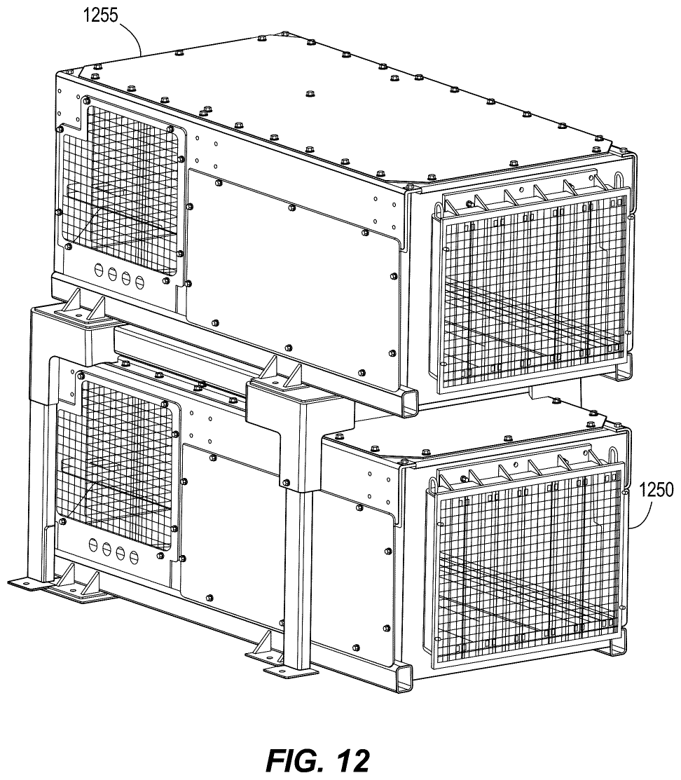

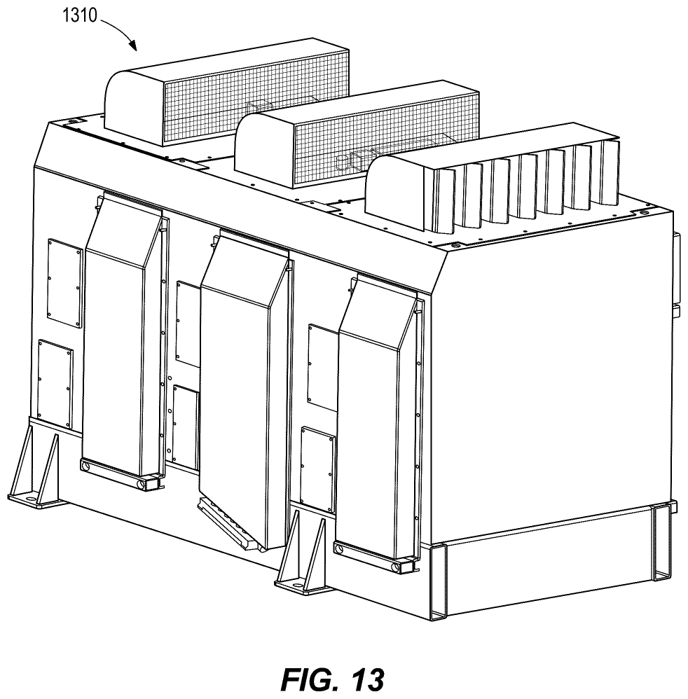

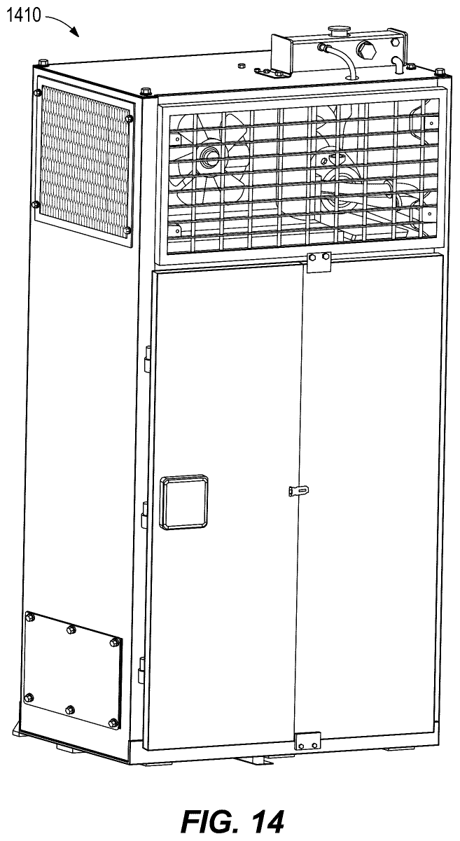

FIG. 7 is a schematic view of a platform layout for a work vehicle in accordance with an example embodiment of the present disclosure. FIG. 8 is a perspective view of retarding grid boxes in accordance with an example embodiment of the present disclosure. FIG. 9 is a perspective view of a trolley box in accordance with an example embodiment of the present disclosure. FIG. 10 is a perspective view of a trolley contacting box in accordance with an example embodiment of the present disclosure. FIG. 11 is a schematic view of a platform layout for a work vehicle in accordance with an example embodiment of the present disclosure. FIG. 12 is a perspective view of retarding grid boxes in accordance with an example embodiment of the present disclosure. FIG. 13 is a perspective view of a battery transformer package in accordance with an example embodiment of the present disclosure. FIG. 14 is a perspective view of an auxiliary power box in accordance with an example embodiment of the present disclosure.

FIGS. 7-14 show example sizes of some features discussed above with reference to FIGS. 1-6 that fit within the space constraints on an example platform of a work vehicle, e.g., platform 32 of work vehicle 10 of FIG. 1. With reference to FIGS. 7-8, when three retarding grid boxes are provided, e.g., retarding grid boxes 350, 355, 360 of the FIG. 3 example, a total designated area on the platform for the retarding grid boxes may be about 60.8 square feet (ft²). A first retarding grid box 850, e.g., the first retarding grid box 350 of FIG. 3, may have dimensions, for example, of about 50.2″ (inches)(1275.2 mm) wide by 38.4″ (975 mm) height by 84″ (2132 mm) depth, including a housing frame portion. A second retarding grid box 855, e.g., the second retarding grid box 355 of FIG. 3, stacked on the first retarding grid box 850, may have dimensions, for example, of about 50.2″ (1275.2 mm) wide by 32.7″ (830.8 mm) height by 84″ (2132 mm) depth, including a housing frame portion. A third retarding grid box 860, e.g., the third retarding grid box 360 of FIG. 3, next to the first retarding grid box 850, may have dimensions, for example, of about 50.6″ (1286 mm) wide by 32.7″ (830.8 mm) height by 84″ (2132 mm) depth, including a housing frame portion. The two-box stack may have a total height of about 71.1″ (1805.8 mm). It should be appreciated that the measurements disclosed herein are provided only as examples, and embodiments are not limited thereto. Each of the retarding grid boxes 850, 855, 860 may respectively include a housing 865, a frame 870, and a vent 875 at least at one end of the housing 865, the vent opening being configured to allow the dissipating heat to pass therethrough.

With reference to FIGS. 7 and 9, an optional trolley box 910, e.g., trolley control box 370 or trolley control box 570, may have a designated area of about 7.2 ft². The trolley box 910 may have dimensions, for example, of about 38.8″ (986 mm) wide by 59.7″ (1515.8 mm) height by 26.7″ (677.2 mm) depth. With reference to FIGS. 7 and 10, a trolley contacting box 1010 may be mounted, for example, under the platform, and may have a designated area of about 9.8 ft². The trolley contacting box 1010 may have dimensions, for example, of about 34.9″ (887.5 mm) wide by 19.4″ (493.9 mm) height by 23″ (586 mm) depth. For example, the trolley box 910 may receive external electrical energy as the power source. It should be appreciated that the measurements disclosed herein are provided only as examples, and embodiments are not limited thereto.

With reference to FIGS. 11-12, when two retarding grid boxes are provided, e.g., retarding grid boxes 550, 555 of the FIG. 5 example, a total designated area on the platform for the retarding grid boxes may be about 31.3 square feet (ft²). A first retarding grid box 1250, e.g., the first retarding grid box 550 of FIG. 5, may have dimensions, for example, of about 52.7″ (1338.4 mm) wide by 38.4″ (975 mm) height by 84″ (2132 mm) depth, including a housing frame portion. A second retarding grid box 1255, e.g., the second retarding grid box 555 of FIG. 5, stacked on the first retarding grid box 1250, may have dimensions, for example, of about 50.2″ (1275.2 mm) wide by 32.7″ (830.8 mm) height by 84″ (2132 mm) depth, including a housing frame portion. The two-box stack may have a total height of about 71.1″ (1805.8 mm). It should be appreciated that the measurements disclosed herein are provided only as examples, and embodiments are not limited thereto.

With reference to FIGS. 11 and 13, a battery transformer package 1310, e.g., for the power reclaiming unit 560 of FIG. 5, may have a designated area of about 29.5 ft². The battery transformer package 1310 may have dimensions, for example, of about 46.7″ (1185.7 mm) wide by 58″ (1474 mm) height by 83.9″ (2130.5 mm) depth. With reference to FIGS. 11 and 14, an auxiliary power box 1410, e.g., the auxiliary power unit 580 of FIG. 5, may have a designated area of about 9.5 ft². The auxiliary power box 1410 may have dimensions, for example, of about 44.2″ (1122.4 mm) wide by 88.1″ (2237.6 mm) height by 29.2″ (740.8 mm) depth. It should be appreciated that the measurements disclosed herein are provided only as examples, and embodiments are not limited thereto.

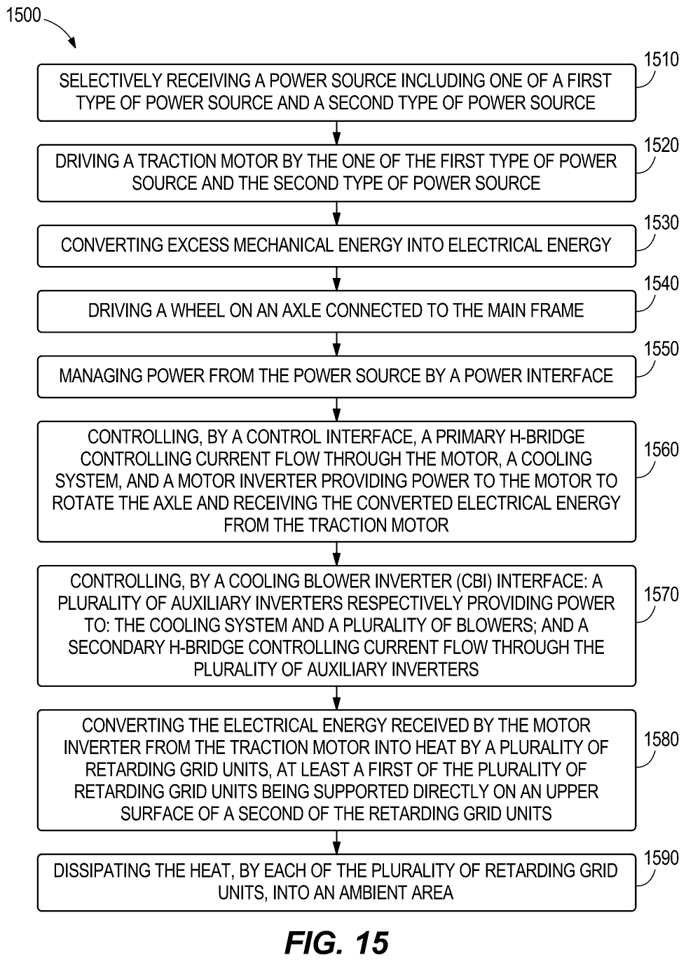

FIG. 15 is a flowchart of a method in accordance with an example embodiment of the present disclosure.

FIG. 15 shows an example method 1500 for operating a work vehicle. The example method 1500 may include, at 1510, selectively receiving, at a main frame, a power source including one of a first type of power source and a second type of power source, the first type of power source being different from the second type of power source. The example method 1500 may further include, at 1520, driving a traction motor, connected to the main frame, by the one of the first type of power source and the second type of power source. The example method 1500 may further include, at 1530, converting, by the traction motor, excess mechanical energy into electrical energy. The example method 1500 may further include, at 1540, driving, by the traction motor, a wheel on an axle connected to the main frame. The example method 1500 may further include, at 1550, managing power from the power source by a power interface disposed on a platform connected to the main frame in a position higher than the wheel. The example method 1500 may further include, at 1560, controlling, by a control interface disposed on the platform: a primary H-bridge controlling current flow through the motor, a cooling system, and a motor inverter providing power to the motor to rotate the axle and receiving the converted electrical energy from the traction motor. The example method 1500 may further include, at 1570, controlling, by a cooling blower inverter (CBI) interface disposed on the platform: a plurality of auxiliary inverters respectively providing power to: the cooling system; and a plurality of blowers, and a secondary H-bridge controlling current flow through the plurality of auxiliary inverters. The example method 1500 may further include, at 1580, converting the electrical energy received by the motor inverter from the traction motor into heat by a plurality of retarding grid units disposed on the platform, at least a first of the plurality of retarding grid units being supported directly on an upper surface of a second of the retarding grid units. The example method 1500 may further include, at 1590, dissipating the heat, by each of the plurality of retarding grid units, into an ambient area.

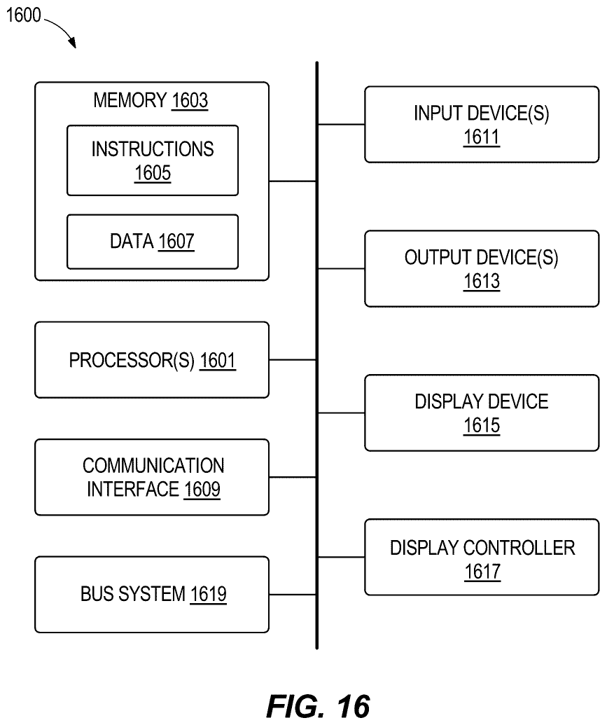

FIG. 16 illustrates certain components that may be included within a computer system according to an example embodiment of the present disclosure.

FIG. 16 illustrates certain components that may be included within a computer system 1600, which may be used to control the work vehicle according to an example embodiment in accordance with the present disclosure. One or more computer systems 1600 may be used to implement the various devices, components, and systems described herein.

FIG. 16 illustrates certain components that may be included within a computer system 1600, which may be used to control features according to embodiments of the present disclosure, such as the features discussed with reference to FIGS. 1-15. One or more computer systems 1600 may be used to implement the various devices, components, and systems described herein.

The computer system 1600 includes one or more processors 1601. The processor(s) 1601 may be a single processor or may include multiple processors and/or sub-processors. The processor(s) 1601 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor(s) 1601 may be referred to as a central processing unit (CPU). Although a single processor(s) 1601 is shown in the computer system 1600 of FIG. 16, in an alternative configuration, a combination of processors (e.g., an ARM and DSP) could be used. In one or more embodiments, the computer system 1600 further includes one or more graphics processing units (GPUs), which can provide processing services related to both entity classification and graph generation.

The computer system 1600 also includes memory 1603 in electronic communication with the processor(s) 1601. The memory 1603 may be any electronic component capable of storing electronic information. For example, the memory 1603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory device or multiple memory devices.

Instructions 1605 and data 1607 may be stored in the memory 1603. The instructions 1605 may be executable by the processor(s) 1601 to implement some or all of the functionality disclosed herein. Executing the instructions 1605 may involve the use of the data 1607 that is stored in the memory 1603. Any of the various examples of modules and components described herein may be implemented, partially or wholly, as instructions 1605 stored in memory 1603 and executed by the processor(s) 1601. Any of the various examples of data described herein may be among the data 1607 that is stored in memory 1603 and used during execution of the instructions 1605 by the processor(s) 1601.

A computer system 1600 may also include one or more communication interfaces 1609 for communicating with other electronic devices. The communication interface(s) 1609 may be based on wired communication technology, wireless communication technology, or both. Some examples of communication interfaces 1609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1600 may also include one or more input devices 1611 and one or more output devices 1613. Some examples of input devices 1611 include a keyboard, mouse, microphone, remote control device, button, joystick, trackball, touchpad, and lightpen. Some examples of output devices 1613 include a speaker and a printer. One specific type of output device that is typically included in a computer system 1600 is a display device 1615. Display devices 1615 used with embodiments disclosed herein may utilize any suitable image projection technology, such as liquid crystal display (LCD), light-emitting diode (LED), gas plasma, electroluminescence, or the like. A display controller 1617 may also be provided, for converting data 1607 stored in the memory 1603 into text, graphics, and/or moving images (as appropriate) shown on the display device 1615.

The various components of the computer system 1600 may be coupled together by one or more buses, which may include a power bus, a control signal bus, a status signal bus, a data bus, etc. For the sake of clarity, the various buses are illustrated in FIG. 16 as a bus system 1619.

The following are sections in accordance with at least one embodiment of the present disclosure:

Clause 1: A work vehicle, including: a main frame configured to selectively receive a power source including one of a first type of power source and a second type of power source, the first type of power source being different from the second type of power source, a traction motor connected to the main frame, the traction motor being configured to: be driven by the one of the first type of power source and the second type of power source, and convert excess mechanical energy into electrical energy, a wheel on an axle connected to the main frame, the wheel on the axle being configured to be driven by the traction motor, a platform connected to the main frame in a position higher than the wheel, a power interface disposed on the platform, the power interface being configured to manage power from the power source, a control interface disposed on the platform, the control interface being configured to control: a primary H-bridge configured to control current flow through the motor, a cooling system, and a motor inverter configured to: provide power to the motor to rotate the axle, and receive the converted electrical energy from the traction motor, a cooling blower inverter (CBI) interface disposed on the platform, the CBI interface being configured to control: a plurality of auxiliary inverters respectively configured to provide power to: the cooling system, and a plurality of blowers, and a secondary H-bridge configured to control current flow through the plurality of auxiliary inverters, and a plurality of retarding grid units disposed on the platform, at least a first of the plurality of retarding grid units being supported directly on an upper surface of a second of the retarding grid units, each of the plurality of retarding grid units being configured to: convert the electrical energy received by the motor inverter from the traction motor into heat, and dissipate the heat into an ambient area.

Clause 2: The work vehicle of clause 1, wherein: the power source includes a combustion engine, and a number of the plurality of retarding grid units is three.

Clause 3: The work vehicle of clause 1, wherein: the power source includes a rechargeable energy storage unit, a number of the plurality of retarding grid units is two, and the work vehicle further includes a power reclaiming unit configured to: receive electrical energy from the motor inverter, convert at least a portion of the electrical energy received from the motor inverter into a DC electrical energy, and store the DC electrical energy in the rechargeable energy storage unit.

Clause 4: The work vehicle of clause 3, wherein, when the electrical energy received from the motor inverter is greater than a storage capacity of the rechargeable energy storage unit, the plurality of retarding grid units is further configured to dissipate a portion of the received electrical energy corresponding to the electrical energy that is greater than a storage capacity of the rechargeable energy storage unit.

Clause 5: The work vehicle of clause 1, wherein each of the plurality of retarding grid units includes: one or more resistor banks, each of the one or more resistor banks respectively including one or more resistors, each of the one or more resistors being configured to: receive electrical energy from the motor inverter, and convert the electrical energy into heat, a blower configured to pass air over the one or more resistor banks to dissipate the heat into the ambient area, and a housing configured to surround the one or more resistor banks and the blower, the housing including: a frame, and a vent opening at least at one end of the housing, the vent opening being configured to allow the dissipating heat to pass therethrough.

Clause 6: The work vehicle of clause 5, wherein: the power source is configured to be replaced with a replacement power source having a different type of power source from the power source, and when the power source is replaced with a replacement power source, when the power source is a combustion engine, and when the replacement power source is a rechargeable energy storage unit, the work vehicle is configured such that at least one of the plurality of retarding grid units is replaced with a power reclaiming unit configured to: receive the electrical energy from the motor inverter, convert at least a portion of the electrical energy received from the motor inverter into a DC electrical energy, and store the DC electrical energy in the rechargeable energy storage unit.

Clause 7: The work vehicle of clause 5, wherein: the power source is configured to be replaced with a replacement power source having a different type of power source from the power source, and when the power source is replaced with a replacement power source, when the power source is a rechargeable energy storage unit, and when the replacement power source is a combustion engine, the work vehicle is configured such that a power reclaiming unit configured to convert at least a portion of the electrical energy received from the motor inverter into a DC electrical energy is replaced with at least one more of the plurality of retarding grid units.

Clause 8: The work vehicle of clause 1, further including a trolley box disposed on the platform, the trolley box being configured to receive external electrical energy as the power source.

Clause 9: The work vehicle of clause 1, wherein the cooling system includes a liquid cooling system.

Clause 10: A method for operating a work vehicle, the method including: selectively receiving, at a main frame, a power source including one of a first type of power source and a second type of power source, the first type of power source being different from the second type of power source, driving a traction motor, connected to the main frame, by the one of the first type of power source and the second type of power source, and converting, by the traction motor, excess mechanical energy into electrical energy, driving, by the traction motor, a wheel on an axle connected to the main frame, managing power from the power source by a power interface disposed on a platform connected to the main frame in a position higher than the wheel, controlling, by a control interface disposed on the platform: a primary H-bridge controlling current flow through the motor, a cooling system, and a motor inverter: providing power to the motor to rotate the axle, and receiving the converted electrical energy from the traction motor, controlling, by a cooling blower inverter (CBI) interface disposed on the platform: a plurality of auxiliary inverters respectively providing power to: the cooling system, and a plurality of blowers, and a secondary H-bridge controlling current flow through the plurality of auxiliary inverters, and converting the electrical energy received by the motor inverter from the traction motor into heat by a plurality of retarding grid units disposed on the platform, at least a first of the plurality of retarding grid units being supported directly on an upper surface of a second of the retarding grid units, and dissipating the heat, by each of the plurality of retarding grid units, into an ambient area.

Clause 11: The method of clause 10, wherein: the power source includes a combustion engine, and a number of the plurality of retarding grid units is three.

Clause 12: The method of clause 10, wherein: the power source includes a rechargeable energy storage unit, a number of the plurality of retarding grid units is two, and the method further includes: receiving electrical energy, by a power reclaiming unit of the work vehicle, from the motor inverter, converting, by the power reclaiming unit, at least a portion of the electrical energy received from the motor inverter into a DC electrical energy, and storing, by the power reclaiming unit, the DC electrical energy in the rechargeable energy storage unit.

Clause 13: The method of clause 12, further including, when the electrical energy received from the motor inverter is greater than a storage capacity of the rechargeable energy storage unit, the plurality of retarding grid units dissipating a portion of the received electrical energy corresponding to the electrical energy that is greater than a storage capacity of the rechargeable energy storage unit.

Clause 14: The method of clause 10, wherein each of the plurality of retarding grid units includes: one or more resistor banks, each of the one or more resistor banks respectively including one or more resistors, each of the one or more resistors: receiving electrical energy from the motor inverter, and converting the received electrical energy into heat, a blower passing air over the one or more resistor banks to dissipate the heat into the ambient area, and a housing surrounding the one or more resistor banks and the blower, the housing including: a frame, and a vent opening at least at one end of the housing, the vent opening allowing the dissipating heat to pass therethrough.

Clause 15: The method of clause 14, further including: replacing the power source with a replacement power source having a different type of power source from the power source, and when the power source is replaced with a replacement power source, when the power source is a combustion engine, and when the replacement power source is a rechargeable energy storage unit, replacing at least one of the plurality of retarding grid units with a power reclaiming unit that: receives the electrical energy from the motor inverter, converts at least a portion of the electrical energy received from the motor inverter into a DC electrical energy, and stores the DC electrical energy in the rechargeable energy storage unit.

Clause 16: The method of clause 14, further including: replacing the power source with a replacement power source having a different type of power source from the power source, and when the power source is replaced with a replacement power source, when the power source is a rechargeable energy storage unit, and when the replacement power source is a combustion engine, the work vehicle is configured such that a power reclaiming unit configured to convert at least a portion of the electrical energy received from the motor inverter into a DC electrical energy is replaced with at least one more of the plurality of retarding grid units.

Clause 17: The method of clause 10, further including receiving external electrical energy as the power source via a trolley box disposed on the platform.

Clause 18: The method of clause 10, wherein the cooling system includes a liquid cooling system.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners. Example embodiments are not limited to any particularly-mentioned products, trademarks, or properties.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A work vehicle, comprising:
a main frame configured to selectively receive a power source comprising one of a first type of power source and a second type of power source, the first type of power source being different from the second type of power source;
a traction motor connected to the main frame, the traction motor being configured to:
be driven by the one of the first type of power source and the second type of power source; and
convert excess mechanical energy into electrical energy;
a wheel on an axle connected to the main frame, the wheel on the axle being configured to be driven by the traction motor;
a platform connected to the main frame in a position higher than the wheel;
a power interface disposed on the platform, the power interface being configured to manage power from the power source;
a control interface disposed on the platform, the control interface being configured to control:
a primary H-bridge configured to control current flow through the motor;
a cooling system; and
a motor inverter configured to:
provide power to the motor to rotate the axle; and
receive the converted electrical energy from the traction motor;
a cooling blower inverter (CBI) interface disposed on the platform, the CBI interface being configured to control:
a plurality of auxiliary inverters respectively configured to provide power to:
the cooling system; and
a plurality of blowers; and
a secondary H-bridge configured to control current flow through the plurality of auxiliary inverters; and
a plurality of retarding grid units disposed on the platform, at least a first of the plurality of retarding grid units being supported directly on an upper surface of a second of the retarding grid units, each of the plurality of retarding grid units being configured to:
convert the electrical energy received by the motor inverter from the traction motor into heat; and
dissipate the heat into an ambient area.

2. The work vehicle of claim 1, wherein:
the power source comprises a combustion engine; and
a number of the plurality of retarding grid units is three.

3. The work vehicle of claim 1, wherein:
the power source comprises a rechargeable energy storage unit;
a number of the plurality of retarding grid units is two; and
the work vehicle further comprises a power reclaiming unit configured to:
receive electrical energy from the motor inverter;
convert at least a portion of the electrical energy received from the motor inverter into a DC electrical energy; and
store the DC electrical energy in the rechargeable energy storage unit.

4. The work vehicle of claim 3, wherein, when the electrical energy received from the motor inverter is greater than a storage capacity of the rechargeable energy storage unit, the plurality of retarding grid units is further configured to dissipate a portion of the received electrical energy corresponding to the electrical energy that is greater than a storage capacity of the rechargeable energy storage unit.

5. The work vehicle of claim 1, wherein each of the plurality of retarding grid units comprises:
one or more resistor banks, each of the one or more resistor banks respectively comprising one or more resistors, each of the one or more resistors being configured to:
receive electrical energy from the motor inverter; and
convert the electrical energy into heat;
a blower configured to pass air over the one or more resistor banks to dissipate the heat into the ambient area; and
a housing configured to surround the one or more resistor banks and the blower, the housing comprising a frame, at least one end of the housing comprising a vent opening, the vent opening being configured to allow the dissipating heat to pass therethrough.

6. The work vehicle of claim 5, wherein:
the power source is configured to be replaced with a replacement power source having a different type of power source from the power source; and
when the power source is replaced with a replacement power source, when the power source is a combustion engine, and when the replacement power source is a rechargeable energy storage unit, the work vehicle is configured such that at least one of the plurality of retarding grid units is replaced with a power reclaiming unit configured to:
receive the electrical energy from the motor inverter;
convert at least a portion of the electrical energy received from the motor inverter into a DC electrical energy; and
store the DC electrical energy in the rechargeable energy storage unit.

7. The work vehicle of claim 5, wherein:
the power source is configured to be replaced with a replacement power source having a different type of power source from the power source; and
when the power source is replaced with a replacement power source, when the power source is a rechargeable energy storage unit, and when the replacement power source is a combustion engine, the work vehicle is configured such that a power reclaiming unit configured to convert at least a portion of the electrical energy received from the motor inverter into a DC electrical energy is replaced with at least one more of the plurality of retarding grid units.

8. The work vehicle of claim 1, further comprising a trolley box disposed on the platform, the trolley box being configured to receive external electrical energy as the power source.

9. The work vehicle of claim 1, wherein the cooling system comprises a liquid cooling system.

10. A method for operating a work vehicle, the method comprising:
selectively receiving, at a main frame, a power source comprising one of a first type of power source and a second type of power source, the first type of power source being different from the second type of power source;
driving a traction motor, connected to the main frame, by the one of the first type of power source and the second type of power source; and
converting, by the traction motor, excess mechanical energy into electrical energy;
driving, by the traction motor, a wheel on an axle connected to the main frame;
managing power from the power source by a power interface disposed on a platform connected to the main frame in a position higher than the wheel;
controlling, by a control interface disposed on the platform:
a primary H-bridge controlling current flow through the motor;
a cooling system; and
a motor inverter:
providing power to the motor to rotate the axle; and
receiving the converted electrical energy from the traction motor;
controlling, by a cooling blower inverter (CBI) interface disposed on the platform:
a plurality of auxiliary inverters respectively providing power to:
the cooling system; and
a plurality of blowers; and
a secondary H-bridge controlling current flow through the plurality of auxiliary inverters; and
converting the electrical energy received by the motor inverter from the traction motor into heat by a plurality of retarding grid units disposed on the platform, at least a first of the plurality of retarding grid units being supported directly on an upper surface of a second of the retarding grid units; and
dissipating the heat, by each of the plurality of retarding grid units, into an ambient area.

11. The method of claim 10, wherein:
the power source comprises a combustion engine; and
a number of the plurality of retarding grid units is three.

12. The method of claim 10, wherein:
the power source comprises a rechargeable energy storage unit;
a number of the plurality of retarding grid units is two; and
the method further comprises:
receiving electrical energy, by a power reclaiming unit of the work vehicle, from the motor inverter;
converting, by the power reclaiming unit, at least a portion of the electrical energy received from the motor inverter into a DC electrical energy; and
storing, by the power reclaiming unit, the DC electrical energy in the rechargeable energy storage unit.

13. The method of claim 12, further comprising, when the electrical energy received from the motor inverter is greater than a storage capacity of the rechargeable energy storage unit, the plurality of retarding grid units dissipating a portion of the received electrical energy corresponding to the electrical energy that is greater than a storage capacity of the rechargeable energy storage unit.

14. The method of claim 10, wherein each of the plurality of retarding grid units comprises:
one or more resistor banks, each of the one or more resistor banks respectively comprising one or more resistors, each of the one or more resistors:
receiving electrical energy from the motor inverter; and
converting the received electrical energy into heat;
a blower passing air over the one or more resistor banks to dissipate the heat into the ambient area; and
a housing surrounding the one or more resistor banks and the blower, the housing comprising a frame, at least one end of the housing comprising a vent opening, the vent opening allowing the dissipating heat to pass therethrough.

15. The method of claim 14, further comprising:
replacing the power source with a replacement power source having a different type of power source from the power source; and
when the power source is replaced with a replacement power source, when the power source is a combustion engine, and when the replacement power source is a rechargeable energy storage unit, replacing at least one of the plurality of retarding grid units with a power reclaiming unit that:
receives the electrical energy from the motor inverter;
converts at least a portion of the electrical energy received from the motor inverter into a DC electrical energy; and
stores the DC electrical energy in the rechargeable energy storage unit.

16. The method of claim 14, further comprising:
replacing the power source with a replacement power source having a different type of power source from the power source; and
when the power source is replaced with a replacement power source, when the power source is a rechargeable energy storage unit, and when the replacement power source is a combustion engine, the work vehicle is configured such that a power reclaiming unit configured to convert at least a portion of the electrical energy received from the motor inverter into a DC electrical energy is replaced with at least one more of the plurality of retarding grid units.

17. The method of claim 10, further comprising receiving external electrical energy as the power source via a trolley box disposed on the platform.

18. The method of claim 10, wherein the cooling system comprises a liquid cooling system.
